(19) United States
(12) Patent Application Publication
(10) Pub. No.: US 2020/0332955 A1
(43) Pub. Date: Oct. 22, 2020

(54) ROBOT CELL

(71) Applicant: Yaskawa Nordic AB, TORSÅS (SE)

(72) Inventor: Carl-Johan HALLENGREN, Ramdala (SE)

(21) Appl. No.: 16/960,627

(22) PCT Filed: Jan. 11, 2019
(86) PCT No.: PCT/EP2019/050624

§ 371 Date: Jul. 8, 2020

(30) Foreign Application Priority Data
Jan. 12, 2018 (SE) 1850036-3

(51) Int. Cl. F16P 1/06; F16P 3/08; E06B 3/90; E06B 3/70; B25J 21/00

(52) U.S. Cl. CPC F16P 1/06; F16P 3/08; E06B 2003/7048; E06B 3/7007; B25J 21/00; E06B 3/903

(57) ABSTRACT

The invention relates to a robot cell comprising a protective casing, which surrounds a robot, and at least one station, which is served by the robot. A door assembly is provided on the protective casing in order to, in an open position, provide access to an access opening through which the station from the outside of the protective casing can be served by an operator, and in order to, in a closed position, close the access opening. The door assembly comprises a door leaf, which from the closed position of the door assembly is movable aside along an arcuate path and into the protective casing, in which the door leaf in the open position of the door assembly closes a passageway within the protective casing between the robot and the station, wherein the arcuate path follows a circular arc around a vertical geometric axis (A) through a central portion of the station.

### TECHNICAL FIELD

The present invention relates to a robot cell comprising a protective casing, which surrounds a robot, and at least one station, which is served by the robot, wherein a door assembly is provided on the protective casing in order to, in an open position, provide access to an access opening through which the station from the outside of the protective casing can be served by an operator, and in order to, in a closed position, close the access opening.

### PRIOR ART

A robot cell according to the preamble is known, for example, from U.S. Pat. No. 7,238,916 B2. The known robot cell comprises two adjacent door assemblies each comprising two door leaves. These are pivotable about vertical axes and furthermore at least partly displaceable into a station in behind for the purpose of shielding a welding arc.

### OBJECT OF THE INVENTION

In an open position the known door assemblies offer insufficient protection against light from a welding arc and in addition to physical contact with a robot placed inside the protective casing, since large open spaces remain between the station in question and the robot. Against this background, it is an object of the present invention to provide improved protection for an operator of a robot cell.

### BRIEF SUMMARY OF THE INVENTION

According to the present invention, this object is achieved in that the door assembly comprises a door leaf, which from the closed position of the door assembly is movable aside along an arcuate path and into the protective casing, in which the door leaf in the open position of the door assembly closes a passageway within the protective casing between the robot and the station wherein the arcuate path follows a circular arc around a vertical geometric axis through a central portion of the station.

By creating a distinct passageway within the protective casing between a space in which the robot is located and a station which can be served by an operator from the outside of the protective casing, a well defined aperture is provided which, like an access opening, can be reliably closed by a door assembly. According to the invention, it comprises just one door leaf used to alternately close the access opening and said passageway, which means that the door assembly becomes both simple and robust and, in addition, can work very quickly, which is beneficial for the working rate of the robot cell. Furthermore, the arcuate path that the door leaf follows creates a maximum space inside a station in both positions of the door assembly, which is beneficial for both an operator and a robot serving the station. And finally, the improved shielding of the robot, when the door assembly is in its open position to provide an operator to access the station, renders it possible for the shielded robot to, for example, perform maintenance or calibration work instead of resting in a standby mode. It is realized that this can also help to increase the working rate of the robot cell.

Preferably, the door leaf has a width that exceeds an opening width of the access opening, wherein the door leaf in the closed position is arranged to have a front edge abut an opening edge of the access opening and to have a projecting rear portion extend a distance behind an opposed opening edge of the access opening. The advantage of such a solution is that it facilitates reliable closure especially when welding, because the projecting rear portion forms a light lock together with the protective casing.

Preferably, the door leaf is rigid and corresponds to a casing sector of a straight cylinder. Such a door leaf is easy to accomplish, for example, of sheet metal.

Moreover, the door leaf is preferably pivotally suspended on a roof portion of the protective casing by means of at least one pivot arm. An advantage of such suspension on a roof portion of the protective casing is that it leaves a floor surface of the station free, for example, for a workpiece fixture.

Alternatively, the door leaf is pivotally suspended on a roof portion of the protective casing by means of an arcuate rail. Such a solution can also create a free floor area but does probably require more maintenance than a pivot arm solution.

Preferably, the door leaf is pivotable by means of a cylinder assembly disposed in the roof portion of the protective casing. A cylinder assembly is a simple and robust solution and is particularly easy to apply to a pivot arm solution, where the cylinder assembly can interact directly with the pivot arm and a rather short stroke suffices to provide a full opening and closing movement. However, a person skilled in the art will realize that even a motor solution is very well possible.

According to one embodiment, the protective casing surrounds two adjacent stations disposed on each side of the robot and each having an access opening that is closable alternately by means of one door leaf each according to any of the preceding claims. The advantage of such a solution is that it enables maximum utilization of the capacity oa a robot as it always has access to an outwardly closed station in which it can perform a programmed operation while an operator simultaneously performs work in the other station.

Preferably, the access openings of the two stations are arranged next to each other along a front of the protective casing. The advantage of this is that such a design renders it easier for an operator to access and serve the two stations.

### BRIEF SUMMARY OF THE DRAWINGS

The invention will now be described in more detail with reference to the accompanying drawings, in which:

FIG. 1 shows a robot cell according to a first embodiment in a perspective oblique front and top view;

FIG. 2 shows the robot cell of FIG. 1 with a ceiling portion removed in a top view;

FIG. 3 shows the robot cell of FIG. 1 with a door device in an open position;

FIG. 4 shows the robot cell of FIG. 3 with a ceiling portion removed in a top view;

FIG. 5 shows a robot cell according to a second embodiment in a perspective oblique front and top view;

FIG. 6 shows the robot cell of FIG. 5 with a ceiling portion removed and with a door device in an open position; and

FIG. 7 shows the robot cell of FIG. 6 in another perspective oblique front and top view.

### DESCRIPTION OF TWO PREFERRED EMBODIMENTS

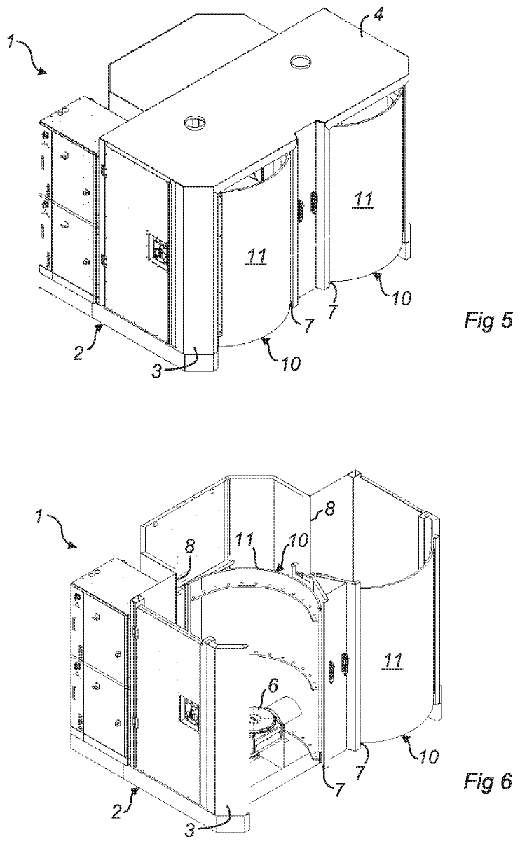

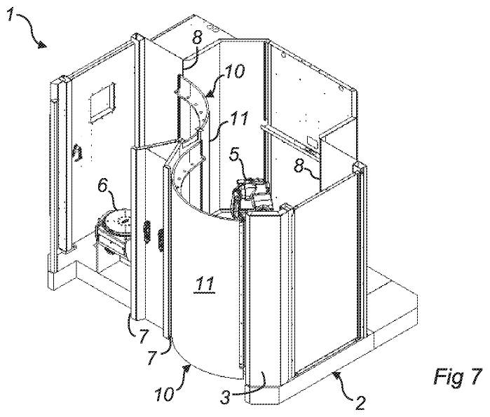

In FIGS. 1-4 and 5-7, respectively, a first and second embodiment of a robot cell according to the invention is shown. For the two embodiments, in the description and the claims similar reference numbers are use to designate corresponding details.

In FIGS. 1-4 a robot cell 1 is shown intended for welding and therefore including a light shielding protective casing 2 with walls 3 and usually a roof 4, as illustrated in FIG. 5 for the second embodiment.

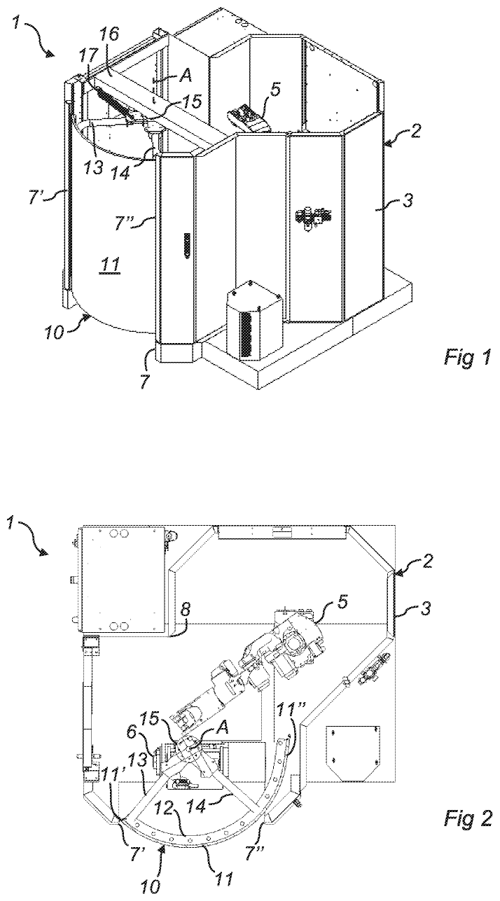

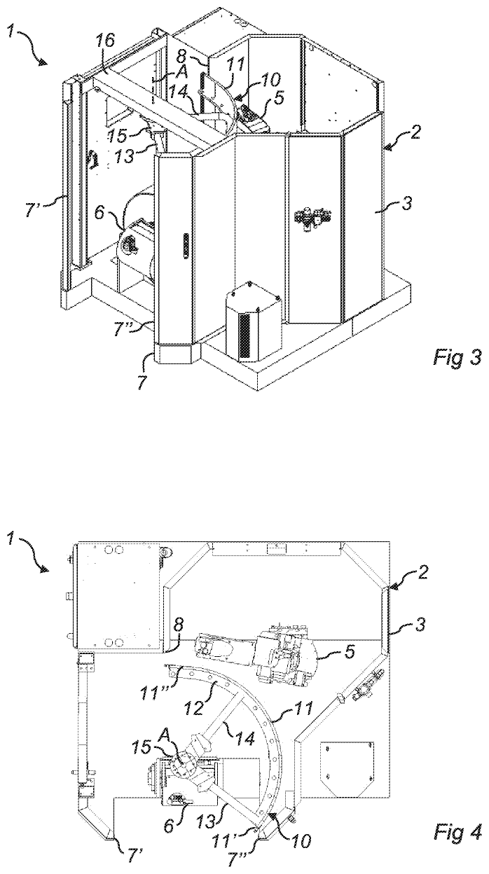

Inside the protective casing 2 there is a robot 5 which is partly hidden in FIGS. 1 and 3 but is clearly seen from above in FIGS. 2 and 4. The robot 5 is arranged to serve a station 6 which is hidden in FIG. 1 but is visible in FIG. 2-4. The station 6 may, for example, include a fixture holding a workpiece while the robot 5 processes it by welding.

The station 6 is accessible to an operator from the outside of the protective casing 2 via an access opening 7 formed in a front of the protective casing 2. The access opening 7 has a fair sized width and extends substantially over the entire height of the protective casing 2 making it possible for an operator to easily change a workpiece or a fixture or to perform, for example, setup work.

Between a portion of the protective casing 2, which houses the robot 5, and a portion of the protective casing 2, which houses the station 6, there is a passageway 8 defined by the walls 3 of the protective casing 2. Also, as in the case of the access opening 7, it has a fair sized width and extends substantially over the entire height of the protective casing 2 but is not intended for an operator but for the robot 5 to easily access the station 6 from its location within the protective casing 2.

In order to close the access opening 7, which is required for outward shielding while the robot is processing a workpiece, and for closing the passageway 8, which is required for shielding of the robot 5 inside the protective casing 2 while an operator performs work inside the protective casing 2, according to the invention a door assembly 10 is provided.

The door assembly 10 comprises a rigid door leaf 11 which has a shape corresponding to a casing sector of a straight cylinder with a vertical geometric axis A extending through a central portion of the station 6. The door leaf 11 is supported by an inner frame 12 from the top of which two arms 13, 14 like spokes project inwardly towards the axis A, where they are connected to a hub 15. The hub 15 is connected to a roof portion 16, here in the form of a beam, enabling pivotion of the door leaf 11 around the vertical axis A.

In order to effect the pivotion, a cylinder assembly 17, shown only in FIG. 1, is provided in the roof portion 16. The cylinder assembly 17 acts between a fixed point of the protective casing 2 and a first 13 of the two arms 13, 14 and has such a stroke that it can turn the door leaf about the axis A about 90°, thus a quarter turn, between two end positions.

The first of these end positions defines the closed position of the door assembly 10, as illustrated in FIGS. 1 and 2, in which the door leaf 11 closes the access opening 7 of the protective casing 2 but leaves the passageway 8 open. The door leaf 11 then with a front edge 11′ abuts a first opening edge 7′ of the access opening 7, and an opposite projecting rear portion 11″ thereof extends inside the protective casing 2 a distance beyond an opposite second opening edge 7″.

Said projecting rear portion 7″ causes the door leaf 11 to cover an arc around the axis A of more than about 90° required for closing of the access opening 7. As a result, on one hand, the door leaf 11 in the closed position of the door assembly 10 forms sort of a light lock at the second opening edge 7″ without the need for direct contact between the door leaf 11 and this opening edge 7″, and, on the other hand, pivotion of the door leaf 11 just a quarter of a turn causes it to cover a greater arc than 90°+90°=180° around axis A.

The second of the two end positions defines the open position of the door assembly 10, as illustrated in FIGS. 3 and 4, in which the door leaf 11 closes the passageway 8 but makes the access opening 7 accessible from the outside. The door leaf 11 then extends from the second opening edge 7″, now the front edge 11′ of the door leaf 11, thus far into the protective casing 2 that the passageway 8 is fully closed by means of the projecting rear portion 11″ of the door leaf 11.

The second embodiment of the robot cell 1 according to the invention differs from the first essentially in that the robot cell 1 comprises two stations instead of one. Of the stations, only one is visible in FIGS. 5-7 and, as in the previous embodiment, it is designated 6.

The stations 6 are generally similar and are within a protective casing 2 arranged on either side of a robot 5. They are accessible from the outside of the protective casing 2 via two adjacent access openings, both designated 7 and formed next to each other in a front of the protective casing 2.

The access openings 7 are designed in the same manner as in the former embodiment, i.e. they both have a first opening edge 7′ and an opposite second opening edge 7″. However, it should be noted that the first opening edges 7′ are located at a greater distance from a center of the front than the other opening edges 7″, i.e. the access openings 7 are, so to speak, mirrored.

Each access opening 7 is closable in the second embodiment by means of a door assembly each, which substantially corresponds to the door assembly 10 described before and thus is designated 10 in FIGS. 5-7 as well and is not described in closer detail. Important to point out, however, is that they are arranged to normally work alternately, i.e. to provide access from from outside either to a first or to a second station 6.

Within the protective casing 2, according to the second embodiment, there no longe is just one but two passageways through which the robot 5 can access the respective station 6. The passagewayss are, like the access openings 7, mirrored and, as in the first embodiment, designated 8. Regarding the purpose of the passageways 8 and their interaction with the door assemblies 10, a closer description appears unnecessary in view of the similarities of the detailed description of the first embodiment. As above, however, it is important to point out that the door assemblies 10 are arranged to normally work alternately, i.e. they do normally previde access for the robot 5 to only one station 6 at a time.

A person skilled in the art will appreciate that it within the scope of the claims is possible to alter the two above-described embodiments in many ways and that it for example is possible to chose another solution for the door blades 11 and for moving them between the open and closed positions than the solution described above.

1. A robot cell comprising:
a protective casing, which surrounds a robot, and at least one station, which is served by the robot, wherein a door assembly is provided on the protective casing in order to, in an open position, provide access to an access opening through which the station from the outside of the protective casing can be served by an operator, and in order to, in a closed position, close the access opening,
wherein the door assembly comprises a door leaf, which from the closed position of the door assembly is movable aside along an arcuate path and into the protective casing, in which the door leaf in the open position of the door assembly closes a passageway within the protective casing between the robot and the station, wherein the arcuate path follows a circular arc around a vertical geometric axis through a central portion of the station.

2. The robot cell according to claim 1, wherein the door leaf has a width that exceeds an opening width of the access opening, wherein the door leaf in the closed position is arranged to have a front edge abut an opening edge of the access opening and to have an projecting rear portion extend a distance behind an opposed opening edge of the access opening.

3. The robot cell according to claim 1, wherein the door leaf is rigid and corresponds to a casing sector of a straight cylinder.

4. The robot cell according to claim 3, wherein the door leaf is pivotally suspended on a roof portion of the protective casing by means of at least one pivot arm.

5. The robot cell according to claim 1, wherein the door leaf is pivotally suspended on a roof portion of the protective casing by means of an arcuate rail.

6. The robot cell according to claim 1, wherein the door leaf is pivotable by means of a cylinder assembly disposed in the roof portion of the protective casing.

7. The robot cell according to claim 1, wherein the protective casing surrounds two adjacent stations disposed on each side of the robot and each having an access opening that is closable alternately by means of one door leaf each.

8. The robot cell according to claim 7, wherein the access openings of the two stations are arranged next to each other along a front of the protective casing.
